(19) United States
(12) Patent Application Publication
(10) Pub. No.: US 2007/0211306 A1
(43) Pub. Date: Sep. 13, 2007

(54) Image forming apparatus and double-sided image forming method

(75) Inventor: Masakazu Abe, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Business Technologies, Inc.

(21) Appl. No.: 11/646,460

(22) Filed: Dec. 28, 2006

(30) Foreign Application Priority Data
Mar. 7, 2006 (JP) 2006-061083

(51) Int. Cl. H04N 1/393

(52) U.S. Cl. 358/451

(57) ABSTRACT

An image forming apparatus including: an image forming section which has a writing head, each head having a plurality of writing elements arranged in a line, and forms images on both sides of a paper sheet; and an image processing section which sends image data to each of the writing elements of the writing head, wherein the image processing section executes a magnification adjustment processing on image data for the front surface and image data for the back surface in an arrangement direction of the writing elements according to a kind of the paper sheet.

### BACKGROUND OF THE INVENTION

1. Field of the Invention

The present invention relates to an image forming apparatus and a double-sided image forming method, in which an image is formed with use of a writing head having a plurality of aligned writing elements.

2. Description of Related Art

Recently, there have been widely used tandem type color printers, color copiers, multi-function machines and the like. This type of color image forming apparatus includes respective image writing units, developing units, photosensitive drums, for yellow (Y), magenta (M), cyan (C), and black (BK) colors, and an intermediate transfer belt and a fixing unit.

For instance, the image writing unit for Y color forms a latent image on the photosensitive drum based on image data for Y color, and the developing unit sticks a Y-color toner on the latent image formed on the photosensitive drum to form a color toner image. The toner image formed on the photosensitive drum is transferred onto the intermediate transfer belt. For each of other M, C and BK colors, the same processing is performed. The color toner image transferred on the intermediate transfer belt is transferred onto a paper sheet and then fixed by the fixing unit.

Regarding the image writing unit, such a unit that has an LED (light emitting diode) head writing optical unit capable of high-speed writing has also been developed. The LED head writing optical unit has a plurality of LED elements aligned in a direction perpendicular to a paper feeding direction, to write writing data on the photosensitive drum simultaneously for each line.

There has been also developed such a color image forming apparatus that can form a color image on both sides of a paper sheet. A double-sided image forming function is used, for example, in producing a pamphlet, where images for a front cover and back cover are respectively formed on a paper sheet. As the paper for a front cover and a back cover, a paper thicker than that of the main body is used in many cases.

It has been also known that the paper shrinks when fixing processing is performed by the fixing unit. This occurs due to heat shrinkage of paper and the thicker paper causes the larger shrinkage. When images are formed on both sides of the paper, an image is formed first on the front and fixing processing is applied thereto. At this time, the paper shrinks to cause a difference in the size of images between the front and back surfaces.

Regarding a magnification adjustment processing function in an LED head writing optical unit, there is disclosed, for example, an image forming apparatus which includes a line type exposure means having a plurality of aligned LED elements, in which pixel density of image information is magnified with interpolating adjustment when the pixel density of image information differs from arrangement density of the LED elements (see JP H9-18697A).

However, in case that the difference in the size of images between the front and the back of a paper sheet in double-sided image forming processing is to be cancelled by magnification adjustment of image data for the back, the image on the back deteriorates in comparison with that on the front. This leads to a problem that the image quality of the front and the back, of the paper differs from each other.

### SUMMARY OF THE INVENTION

An object of the invention is to reduce the difference in image quality between the front and back surfaces of a paper sheet in case of forming images on both sides of the paper, and to equalize the size of images on the front and the back.

In order to achieve the above object, in accordance with a first aspect of the invention, the image forming apparatus comprises: an image forming section which has one or more writing head, each head having a plurality of writing elements arranged in a line, and forms images on both sides of a paper sheet; and an image processing section which sends image data to each of the writing elements of the writing head, wherein the image processing section executes a magnification adjustment processing on image data for the front surface and image data for the back surface in an arrangement direction of the writing elements according to a kind of the paper sheet.

According to the first aspect of the invention, since the magnification adjustment processing is executed on both of the image data for the front surface and the image data for the back surface, the difference in image quality between the front and the back of the paper can be reduced, and the size of images on the front and the back can be equalized to each other.

When executing the magnification adjustment processing, preferably, the image processing section executes a pixel inserting processing on the image data for the front and executes a pixel thinning processing on the image data for the back.

Accordingly, the difference in image quality between the front and the back of the paper can be reduced, and the size of images on the front and the back can be equalized to each other.

Preferably, the number of pixels to be inserted into the image data for the front in the pixel inserting processing is substantially equal to the number of pixels to be thinned out from the image data for the back in the pixel thinning processing.

Accordingly, a ratio to be changed from original data on both of the front-image data and the back-image data may be set by approximately the same rate, whereby the difference in image quality between the front and the back of the paper can be reduced, and the size of images on the front and the back can be equalized to each other.

The image forming apparatus may further comprise a storage section which stores a table correlating kinds of paper with a magnification for the front and a magnification for the back, wherein the image processing section executes a magnification adjustment processing based on the magnification for the front and the magnification for the back, read from the storage section.

The image forming section may comprise a plurality of writing heads corresponding to respective color components of a color image and may form color images on both sides of the paper sheet.

The kind of the paper may be a kind based on a thickness of the paper.

The writing head may be an LED writing head.

In accordance with a second aspect of the invention, the double-sided image forming method for forming images on a first surface and a second surface of a paper sheet with use of a writing head having a plurality of writing elements arranged in a line, comprises the steps of: obtaining a magnification for the first surface and a magnification for the second surface corresponding to a kind of the paper; executing a magnification adjustment processing on image data for the first surface in an arrangement direction of the writing elements based on the magnification for the first surface and sending the magnification-adjusted image data to each of the writing elements of the writing head to form an image of the first surface; and executing a magnification adjustment processing on image data for the second surface in the arrangement direction of the writing elements based on the magnification for the second surface and sending the magnification-adjusted image data to each of the writing element of the writing head to form an image of the second surface.

According to the second aspect of the invention, since the magnification adjustment processing is executed on both of the image data for the first surface and the image data for the second surface, the difference in image quality between the first and the second surfaces of the paper can be reduced, and the size of images on the first and the second surfaces can be equalized to each other.

A pixel inserting processing may be executed on the image data for the first surface when the magnification adjustment processing is executed on the image data for the first surface, and a pixel thinning processing may be executed on the image data for the second surface.

Accordingly, the difference in image quality between the first and the second surfaces of the paper can be reduced, and the size of images on the first and the second surfaces can be equalized to each other.

Preferably, the number of pixels to be inserted into the image data for the first surface in the pixel inserting processing is substantially equal to the number of pixels to be thinned out from the image data for the second surface in the pixel thinning processing.

Accordingly, a ratio to be changed from original data on both of the image data for the first and the second surfaces may be set by approximately the same rate, whereby the difference in image quality between the first and the second surfaces of the paper can be reduced, and the size of images on the first and the second surfaces can be equalized to each other.

In the step of obtaining the magnification for the first surface and the magnification for the second surface, a table which is stored in advance and correlates kinds of paper sheets with the magnification for the first surface and the magnification for the second surface, may be referred for obtaining the magnification for the first surface and the magnification for the second surface corresponding to a kind of paper.

The kind of paper may be a kind based on thickness of the paper.

The writing head may be an LED writing head.

In accordance with a third aspect of the invention, the image forming apparatus comprises: an image forming section which has a writing head having a plurality of writing elements arranged in a line and forms images on both sides of a paper sheet; an image processing section which sends image data to each of the writing elements of the writing head; and a storage section which stores in advance magnifications for the front surface and for the back surface in pairs, wherein the image processing section executes a magnification adjustment processing in an arrangement direction of the writing elements with the magnification for the front surface applied to image data for the front and the magnification for the back surface applied to image data for the back.

According to the third aspect of the invention, since the magnification adjustment processing is executed on both of the image data for the front surface and the image data for the back surface, the difference in image quality between the front and the back of the paper can be reduced, and the size of images on the front and the back can be equalized to each other.

When executing the magnification adjustment processing, the image processing section may execute a pixel inserting processing on the image data for the front, and a pixel thinning processing on the image data for the back.

According to the invention, the difference in image quality between the front and the back of the paper can be reduced, and the size of images on the front and the back can be equalized to each other.

Preferably, the number of pixels to be inserted into the image data for the front in the pixel inserting processing is substantially equal to the number of pixels to be thinned out from the image data for the back in the pixel thinning processing.

Accordingly, a ratio to be changed from original data on both of the front-image data and the back-image data may be set by approximately the same rate, whereby the difference in image quality between the front and the back of the paper can be reduced, and the size of images on the front and the back can be equalized to each other.

The kind of paper may be a kind based on thickness of the paper. The writing head may be an LED writing head.

### BRIEF DESCRIPTION OF THE DRAWINGS

The present invention will become more fully understood from the detailed description given hereinbelow and the accompanying drawings, and these are not intended to limit the present invention, and wherein:

FIG. 1 is a schematic view showing the structure of a color copier 100 according to one embodiment of the invention;

FIG. 2 is a perspective view showing the structure of an LED writing unit 3Y and its peripheral circuits;

FIG. 3 is a block diagram showing the structure of a control system in the color copier 100;

FIG. 4 is a block diagram showing the structure of LED writing units 3Y, 3M, 3C and 3k for Y, M, C and BK colors, respectively, and their peripheral circuits;

FIG. 5 is a block diagram showing an example of control from inputting of an image to writing by the LED writing unit;

FIG. 6A is an explanatory view showing an inserting processing with respect to image data for a front surface, and 6B a thinning processing to image data for a back surface; and

FIG. 7 is a flowchart showing an image forming processing executed by the color copier 100.

### DETAILED DESCRIPTION OF THE PREFERRED EMBODIMENT

Hereinafter, the color copier 100 as an image forming apparatus according to one embodiment of the invention will be explained with reference to the drawings.

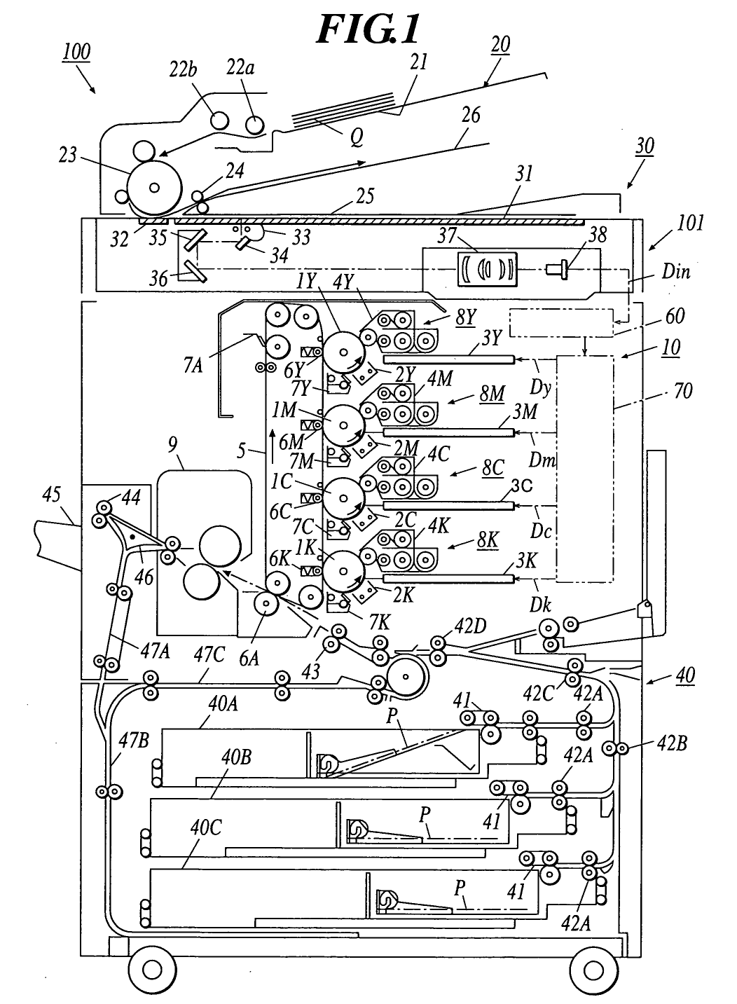

FIG. 1 is a schematic view showing the structure of the color copier 100.

The color copier 100 is an apparatus that reads an image from a document Q to obtain image data and forms a color image based on the image data. As an example of the image forming apparatus of the invention, the color copier 100 is described in the embodiment, however, the invention is applicable to color printers, facsimiles, multi-functional machines, and the like.

As shown in FIG. 1, the color copier 100 has a copier main body 101. At an upper position of the copier main body 101, an automatic document feeding device (ADF) 20 and an image input section 30 are provided. The ADF 20 operates, in an ADF mode, to automatically feed one or more documents Q into the image input section 30. The ADF mode means an operation of automatically feeding a document Q placed on the ADF 20 and automatically reading an image of the document.

The ADF 20 includes document placing section 21, roller 22a, roller 22b, roller 23, transporting roller 24, turning section 25 and document discharge tray 26. One or more documents Q are placed on the document placing section 21. When the ADF mode is selected, the rollers 22a and 22b, provided in a downstream side of the document placing section 21, transport the document Q, and the roller 23 rotatably transports it in a U-shape. The document Q is read by the image input section 30, and, after being read, discharged by the transporting roller 24 to the document discharge tray 26. For a double-sided document, the turning section 25 turns over the document Q, and images on both sides thereof are read out.

The image input section 30 reads a color image formed on the document Q, and outputs image data Dᵢₙ including red (R), green (G) and blue (B) color components. For the image input section 30, for example, a slit-scan type color scanner is used. The image input section 30 includes a first platen glass 31, a second platen glass (ADF glass) 32, a light source 33, mirrors 34, 35 and 36, a focusing optical unit 37, one-dimensional image sensor 38, and an optical drive unit which is not shown.

The light source 33 irradiates light on the document Q. The reflected light from the document Q enters the image sensor 38 through the mirrors 34, 35 and 36, and the focusing optical unit 37.

The optical drive unit moves the document Q or the image sensor 38 relatively in a sub scanning direction. The sub scanning direction is a direction perpendicular to a main scanning direction, which would be defined to be an aligned direction of a plurality of receiving elements constituting the image sensor 38.

The image sensor 38 is a three-line color CCD imaging device, in which three reading line sensors for detecting R, G and B color lights are arranged at a given distance in the sub scanning direction, each line sensor having a plurality of aligned receiving elements. Pixels of the illuminated document Q are divided at different positions in the sub scanning direction, and R, G, and B color light information is read simultaneously.

The image sensor 38 reads an image of the document Q placed on the first platen glass 31 in a platen mode, and reads an image of the document Q in the ADF mode while the document Q passes on the second platen glass 32. The platen mode means an operation of reading an image of the document Q placed on the first platen glass 31.

The image input section 30 is connected to an image processing section 70 through a controller 60.

The image processing section 70 generates writing data for LED writing from image data Dᵢₙ. For instance, the image processing section 70 converts the image data Dᵢₙ (=Dr, Dg, Db) of RGB color system into image data Dy, Dm, Dc, and Dk for Y, M, C and BK colors based on a three-dimensional color information conversion table. The color-converted image data Dy, Dm, Dc, and Dk are transmitted to LED writing units 3Y, 3M, 3C and 3K which constitute an image forming section 10.

The copier main body 101 is a tandem type color image forming apparatus. The main body 101 includes the image forming section 10. The image forming unit 10 forms a color image based on the image data Dy, Dm, Dc, and Dk which are read by the image input section 30.

The image forming section 10 includes image forming units 8Y, 8M, 8C and 8K for respective colors, an intermediate transfer belt 5, a paper feeding and conveying section including a paper re-feed conveying mechanism (ADU mechanism), and a fixing unit 9 for fixing a toner image by heating with pressure.

The image forming unit 8Y for forming an image of yellow (Y) color has photosensitive drum 1Y as an image forming body for forming a Y-color toner image, and charging device 2Y, LED writing unit 3Y, developing unit 4Y and drum cleaning device 7Y, which are arranged around the photosensitive drum 1Y for Y color.

The image forming unit 8M for forming an image of magenta (M) color has a photosensitive drum 1M for forming an M-color toner image, and a charging device 2M, an LED writing unit 3M, a developing unit 4M and a drum cleaning device 7M, which are arranged for M color.

The image forming unit 8C for forming an image of cyan (C) color has a photosensitive drum 1C for forming a C-color toner image, and a charging device 2C, an LED writing unit 3C, a developing unit 4C and a drum cleaning device 7C, which are arranged for C color.

The image forming unit 8K for forming an image of black (BK) color has a photosensitive drum 1K for forming a BK-color toner image, and a charging device 2K, an LED writing unit 3K, a developing unit 4K and a drum cleaning device 7K, which are arranged for BK color.

For each of the LED writing units 3Y, 3M, 3C and 3K, an LED-array head optical unit in which a plurality of LED elements arranged in a line is employed. The developing devices 4Y, 4M, 4C and 4K carry out development by reverse development in which a developing bias voltage is applied with an alternate-current voltage superposed on a direct-current voltage having the same polarity (negative polarity in the embodiment) as that of a used toner.

Respective color toner images formed on the photosensitive drums 1Y, 1M, 1C and 1K are sequentially transferred on the rotating intermediate transfer belt 5 by primary transfer rollers 6Y, 6M, 6C and 6K, to which primary transfer bias voltage is applied, the voltage having a polarity reverse to the used toner (positive polarity in the embodiment), thus superimposed to form a color image (color toner image) (primary transfer).

At a lower position of the image forming unit 10, paper cassettes 40A, 40B and 40C constituting a paper feed and conveying section 40 are provided. A paper sheet P accommodated in the paper cassettes 40A, 40B and 40C is fed by a feed-out roller 41 and a feed roller 42A that are provided on each of the cassettes 40A, 40B and 40C, and conveyed through conveying rollers 42B, 42C and 42D, and registration rollers 43 up to a secondary transfer roller 6A. Then, the secondary transfer roller 6A collectively transfers the color image onto one side surface (front) of the paper P (secondary transfer).

The paper sheet P on which the color image is transferred is subjected to fixing processing by the fixing unit 9, clamped by paper discharge rollers 44, and placed onto a paper discharge tray 45 located outside the apparatus. Toners, remaining on peripheral surfaces of the drums 1Y, 1M, 1C and 1K after the transfer, are removed by the drum cleaning devices 7Y, 7M, 7C and 7K, respectively, and the processing goes into the next image forming cycle.

In case of a double-sided mode in which images are formed on both sides of a paper sheet, an image is first formed on one side (front surface) of the paper P. After the paper P is discharged from the fixing unit 9, the paper P is branched out of the sheet discharging path by a branching member 46. Thereafter, the paper P passes through a paper circulating path 47A located downward to be reversed by a reverse conveying path 47B acting as a paper re-feed conveying mechanism (ADU mechanism), and passes through a paper re-feed conveying unit 47C to be conveyed again.

The reversed and conveyed paper P is conveyed to the secondary transfer roller 6A again through the registration roller 43, where color images (color toner images) are collectively transferred onto the other side (back surface) of the paper P. On the other hand, after the transfer of the color image on the paper P by the secondary transfer roller 6A, an intermediate transfer-belt cleaning device 7A removes residual toners on the intermediate transfer belt 5, which separated the paper P by curvature.

For the paper P, there are used thin paper of 52.3 to 63.9 kg/m² (1,000 sheets), plain paper of 64.0 to 81.4 kg/m² (1,000 sheets), thick paper of 83.0 to 130.0 kg/m² (1,000 sheets), and super thick paper of 150.0 kg/m² (1,000 sheets) or so. For a thickness (paper thickness) of the paper P, a paper sheet of 0.05 to 0.15 mm or so is used.

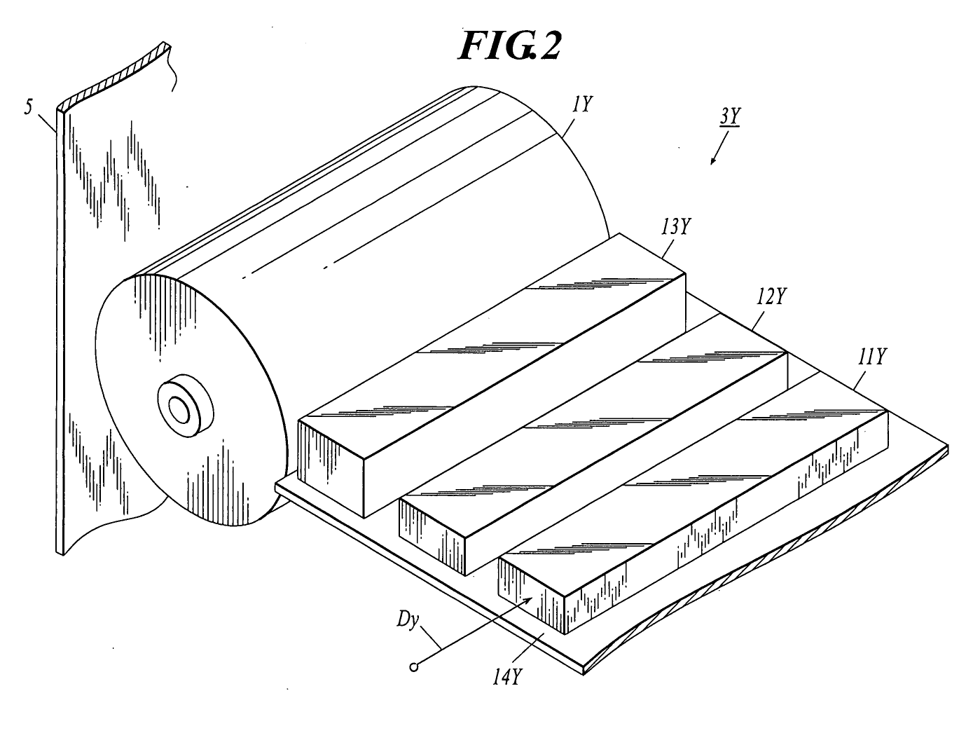

FIG. 2 is a perspective view showing the structure of an LED writing unit 3Y and its peripheral circuits.

As shown in FIG. 2, the LED writing unit 3Y is disposed at a position facing the photosensitive drum 1Y. The writing unit 3Y has an IC-mounted board 14Y. The IC-mounted board 14Y includes a register array 11Y, latch circuits 12Y and an LED head 13Y, which are produced by using semiconductor integrated circuits (IC) and are connected by printed wires or the like, not shown. The LED head 13Y has 7,500 pieces of LED elements aligned at regular intervals with resolution of 600 dpi for A4-sized sheet. The LED head 13Y radiates a group of laser beams from LED elements by respective intensities simultaneously for forming one Y-color line based on one line of image data Dy.

The group of laser beams for forming one Y-color line simultaneously exposes one line on the photosensitive drum 1Y to form one line of latent image. Lines of latent image formed on the photosensitive drum 1Y are developed by the developing unit 4Y shown in FIG. 1 with a Y-color toner. The developed Y-color toner image is transferred onto the intermediate transfer belt 5.

The LED writing units 3M, 3C and 3K have the same structure as that of the LED writing unit 3Y, therefore corresponding parts are designated by the same reference numerals and the description thereof is omitted.

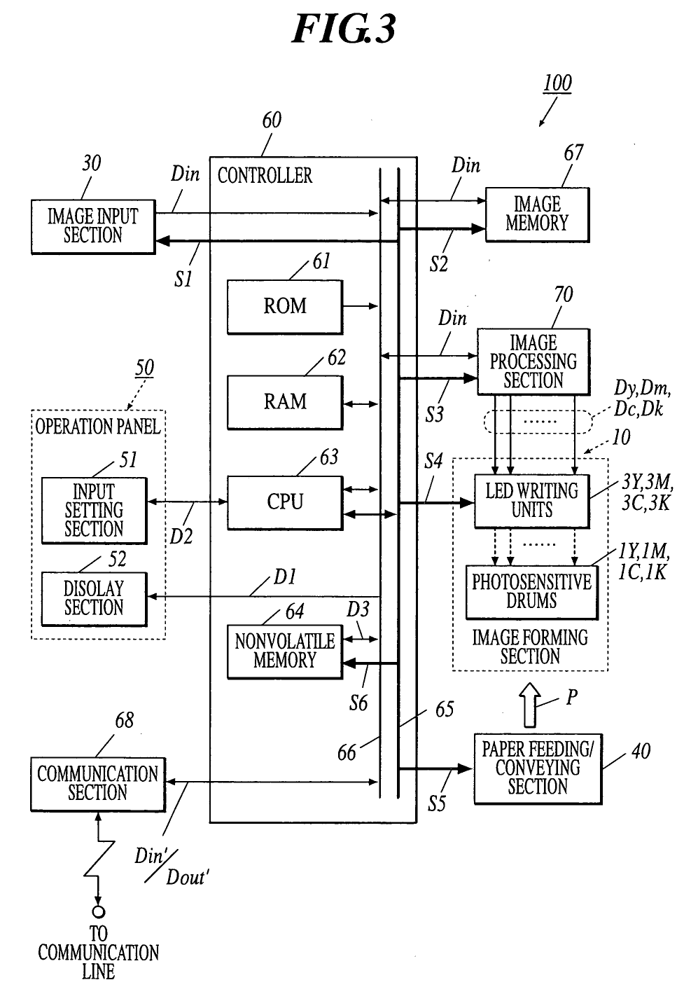

FIG. 3 is a block diagram showing the structure of a control system in the color copier 100. As shown in FIG. 3, the color copier 100 includes a controller 60, an image input section 30, an image memory 67, an image processing section 70, an image forming section 10, an operation panel 50, a paper feeding and conveying section 40, and a communication section 68. These components are connected to each other by a control bus 65 and a data bus 66.

The controller 60 has a ROM (read only memory) 61, a RAM (random access memory) 62, and a CPU (central processing unit) 63. The ROM 61 stores various processing programs for controlling the entire copier. The RAM 62 forms a working area that temporarily stores various programs executed by the CPU 63 and data associated with these programs. The CPU 63 reads out various programs stored in the ROM 61 and controls overall processing operations of respective components of the color copier 100 in cooperation with the programs.

The image input section 30 executes A/D conversion processing on an analogue image read-out signal obtained from a document Q, on the basis of a read control signal S1 output from the CPU 63. The image data Dᵢₙ after A/D conversion are transmitted to the image memory 67 through the data bus 66.

The image data Dᵢₙ are stored in the image memory 67, responding to an image-memory control signal S2 output from the CPU 63. As the image memory 67, a hard disk or the like is used. The CPU 63 executes read/write control of the image data Din in the image memory 67.

The image processing section 70 generates writing data for LED writing from the RGB-color image data Dᵢₙ, responding to an image processing control signal S3 output from the CPU 63. Specifically, the image processing section 70 converts the RGB-color image data Dᵢₙ into image data Dy, Dm, Dc and Dk for YMCK colors, and supplies the image data Dy, Dm, Dc and Dk to the LED writing units 3Y, 3M, 3C and 3K of the image forming section 10 for each line. As the image processing section 70, a DSP (digital signal processor) may be used, or the image processing section may be implemented by software processing.

The image processing section 70 also executes magnification adjustment processing (processing in a magnification adjustment processing section 71 in FIG. 5) on the image data Dy, Dm, Dc and Dk, based on magnifications corresponding to the kind of paper. In the magnification adjustment processing, a pixel inserting processing or a pixel thinning processing is executed, to thereby change an image size in an arranged direction of LED elements (main scanning direction). An image is expanded by execution of a pixel inserting processing, and an image is shrunk by execution of a pixel thinning processing. In the pixel inserting processing, a pixel is inserted every predetermined number of pixels. Generally, the pixel inserting processing is also called as a pixel interpolation processing. In the pixel thinning processing, a pixel is thinned out every predetermined number of pixels.

The image forming section 10 includes the LED writing units 3Y, 3M, 3C and 3K, and the photosensitive drums 1Y, 1M, 1C and 1K. The LED writing units 3Y, 3M, 3C and 3K write respective images on the photosensitive drums 1Y, 1M, 1C and 1K, responding to an image producing control signal S4 output from the CPU 63. For instance, the LED writing unit 3Y for Y color operates to form a Y-color toner image on the photosensitive drum 1Y, based on the image data Dy of Y color for each line and the image producing control signal S4.

The operation panel 50 includes an input setting section 51 having a touch panel, and a display section 52 having a liquid crystal display (LCD) device. The display section 52 displays the image obtained by the image input section 30, setting items associated with image forming conditions, and the like, based on display data D1. The input setting section 51 is operated to input image forming conditions, such as setting of a kind of the paper P on which images are formed by the image forming section 10, setting of image density, selection of paper size, setting of the number of sheets to be copied. The image forming conditions input from the input setting section 51 are output to CPU 63 as operation data D2.

The paper feeding and conveying section 40 selects one of paper cassettes 40A, 40B and 40C responding to a paper-feed control signal S5, and the paper P fed from the paper cassettes 40A, 40B and 40C is conveyed to the image forming section 10.

The CPU 63 is connected to a nonvolatile memory 64

TABLE 1

| | |
|---|---|
| KIND OF | MAGNIFICATION |

| PAPER | FRONT | BACK |
|---|---|---|
| #P1 | L1 | M1 |
| #P2 | L2 | M2 |
| #P3 | L3 | M3 |
| . | . | . |
| . | . | . |
| . | . | . |
| #Pn − 2 | Ln − 2 | Mn − 2 |
| #Pn − 1 | Ln − 1 | Mn − 1 |
| #Pn | Ln | Mn |

The CPU 63 is connected to a nonvolatile memory 64 through the control bus 65 and the data bus 66. The nonvolatile memory 64 stores a table of paper-kind vs. magnification. The table of paper-kind vs. magnification is a table, as shown in TABLE 1, in which kinds of paper #P1-#Pn are correlated with magnifications of the front L1-Ln and magnifications of the back M1-Mn, and stored in the memory. The magnifications of the front L1-Ln and the magnifications of the back M1-Mn are set in advance corresponding to respective heat shrinkage percentages of the paper sheets. When the input setting section 51 selects a kind of paper #P1 or the like, CPU 63 outputs a nonvolatile-memory control signal S6 to the nonvolatile memory 64, and reads out from the nonvolatile memory 64 a magnification data D3 corresponding to the kind of paper #P1 or the like.

The communication section 68 is connected to a communication line such as a LAN, and communicates with external computers, printers and the like. For instance, when a document image read by the color copier 100 is sent out to form the image by an external printer, the communication section 68 transmits print data Dₒᵤₜ, to the external printer. The communication section 68 also receives print data Din, produced by an external computer.

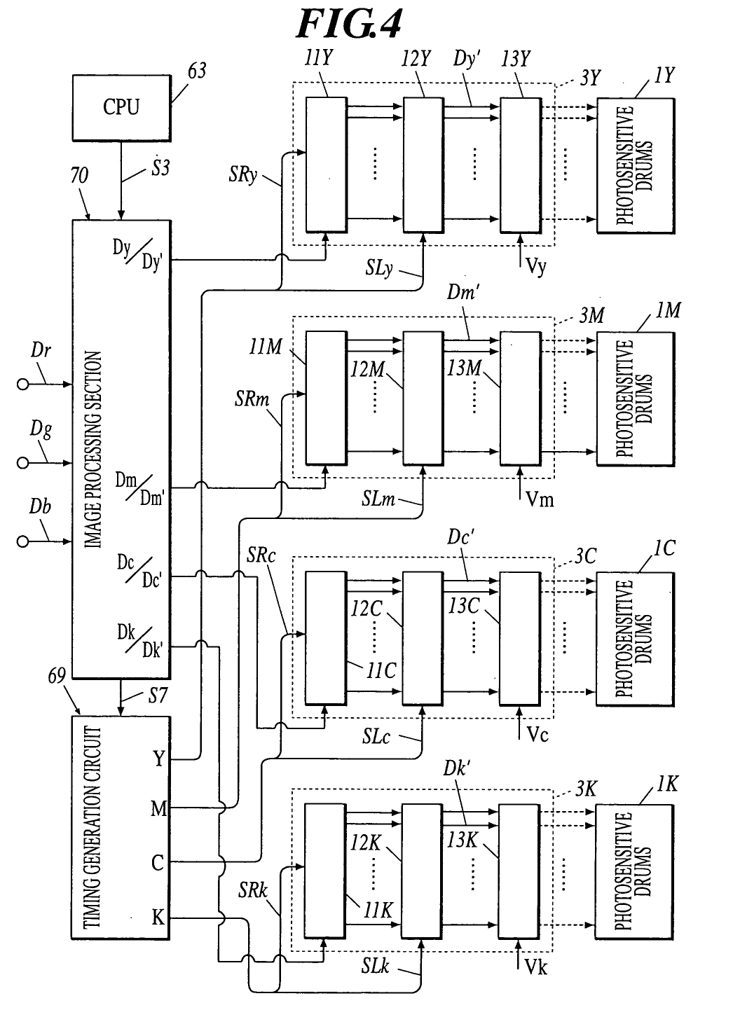

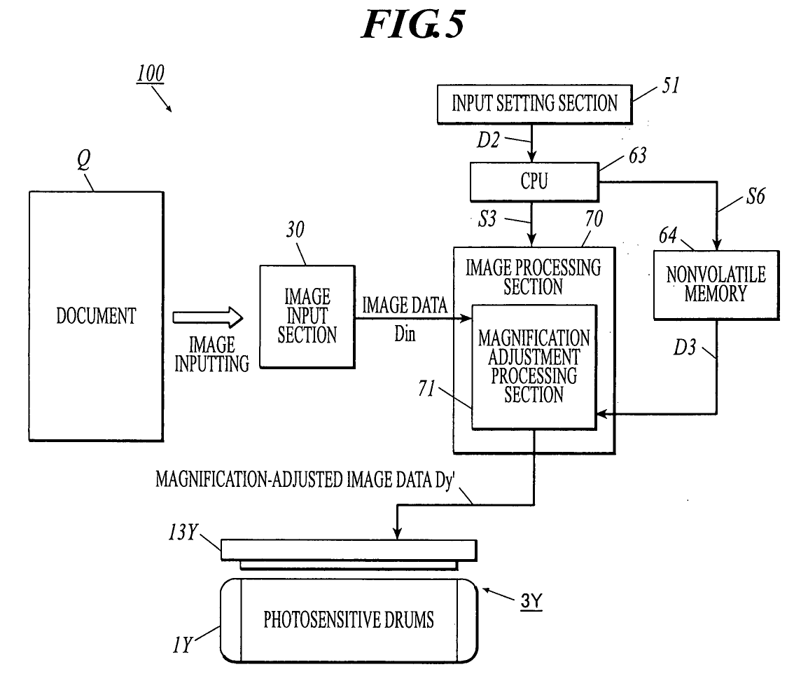

FIG. 4 is a block diagram showing the structure of LED writing units 3Y, 3M, 3C and 3K for Y, M, C and BK colors, respectively, and their peripheral circuits.

As shown in FIG. 4, the CPU 63 is connected to the image processing section 70 and sends an image-processing control signal S3 to the image processing section 70. Responding to the image-processing control signal S3, the image processing section 70 generates writing data corresponding to respective LED elements of the LED heads 13Y, 13M, 13C and 13K from the digital image data Dᵢₙ of R-, G-, B-color components. The image processing section 70 converts in color the image data Dᵢₙ to image data Dy, Dm, Dc and Dk for Y, M, C and BK colors.

In case that a double-sided mode is selected, the image processing section 70, based on the magnification corresponding to the kind of paper, executes magnification adjustment processing on the image data Dy, Dm, Dc and Dk for each line to generate magnification-converted image data Dy′, Dm′, Dc′ and Dk′ (processing executed by the magnification adjustment processing section 71 of FIG. 5). That is, for example, in case that five pages of documents are copied or printed on paper sheets of a kind #P1, magnification L1 is applied to image data for pages 1, 3 and 5, and magnification M1 to image data for pages 2 and 4.

The image processing section 70 sends to the register array 11Y of the LED writing unit 3Y the image data Dy or image data Dy′ corresponding to each pixel of one line. Similarly, the image processing section 70 sends to the register array 11M of the LED writing unit 3M the image data Dm or image data Dm′ corresponding to each pixel of one line, to the register array 11C of the LED writing unit 3C the image data Dc or image data Dc′ corresponding to each pixel of one line, and to the register array 11K of the LED writing unit 3K the image data Dk or image data Dk′ corresponding to each pixel of one line.

A timing generation circuit 69 is connected to the image processing section 70. Based on a timing-generation control signal S7 sent from the image processing section 70, the timing generation circuit 69 generates a register control signal SRy and a latch control signal SLy for Y color, a register control signal SRm and a latch control signal SLm for M color, a register control signal SRc and a latch control signal SLc for C color, and a register control signal SRk and a latch control signal SLk for BK color, respectively.

The image processing section 70 and the timing generation circuit 69 are connected to the LED writing units 3Y, 3M, 3C and 3K for Y, M, C and K colors, respectively. The LED writing unit 3Y has the register array 11Y, latch circuits 12Y and LED head 13Y. Based on the register control signal SRy, the register array 11Y holds the serial image data Dy or Dy′, which are sequentially input for one line.

The register array 11Y is connected to the latch circuits 12Y. Based on the latch control signal SLy, the latch circuits 12Y operate to latch the image data Dy or Dy′ which are output in parallel from the register array 11Y. The latch circuits 12Y are connected to the LED head 13Y.

The LED head 13Y is connected to a laser-drive power supply Vy, and radiates a group of laser beams with respective intensities simultaneously for forming one Y-color line, based on one line of image data Dy or Dy′ sent from the latch circuits 12Y.

As for the register control signals SRm, SRc and SRk for controlling the register array 11M, 11C and 11K, the latch control signals SLm, SLc and SLk for controlling the latch circuits 12M, 12C and 12K, laser-drive power supplies Vm, Vc and Vk which are connected to the LED heads 13M, 13C and 13K, respectively, these are similar to the register control signal SRy, the latch control signal Sly, and the laser-drive power supply Vy, and therefore the description thereof is omitted.

FIG. 5 is a block diagram showing an example of control from inputting of an image to writing by the LED writing unit. FIG. 5 illustrates only the LED writing unit 3Y for Y color, and illustrations for the LED writing units 3M, 3C and 3K are omitted.

The image processing section 70 includes a magnification adjustment processing section 71 that executes magnification adjustment processing on the image data Dy, Dm, Dc and Dk. When the operation data D2 indicating the kind of paper P is input from the input setting section 51, the CPU 63 reads the magnification data D3 corresponding to the kind of paper from the nonvolatile memory 64 to set to the magnification adjustment processing section 71.

For instance, when the operation data D2 indicating a kind of paper (plain paper) is input from the input setting section 51, the CPU 63 outputs the nonvolatile-memory control signal S6 to the nonvolatile memory 64, reads the magnification of the front L1 and the magnification of the back M1 corresponding to the kind of paper #P1 depending on the paper-kind vs. magnification table in the nonvolatile memory 64, to set the magnification to the magnification adjustment processing section 71.

When the document Q is read by the image input section 30, image data Dᵢₙ are input to the image processing section 70. The image processing section 70 color-converts the data Dᵢₙ into image data Dy, Dm, Dc and Dk for Y, M, C and BK colors. Thereafter, based on the magnification data D3, the magnification adjustment processing section 71 executes the magnification adjustment processing on the image data Dy, Dm, Dc and Dk for each line to generate the magnification adjusted image data Dy′, Dm′, Dc′ and Dk′. In case that a double-sided mode is selected, the magnification adjustment processing section 71 executes a pixel inserting processing on image data for the front, and a pixel thinning processing on image data for the back.

The magnification-converted image data Dy′, Dm′, Dc′ and Dk′ are sent to the LED heads 13Y, 13M, 13C and 13K. The LED heads 13Y, 13M, 13C and 13K expose the photosensitive drums 1Y, 1M, 1C and 1K, respectively, based on the image data Dy′, Dm′, Dc′ and Dk′.

Next, a description of magnification adjustment processing in which the magnification adjustment processing section 71 executes on image data Dy′, Dm′, Dc′ and Dk′ having 7,016 pixels (600 dpi in A4 size), will be given.

In case that the heat shrinkage percentage of the paper is 0.2%, for example, when an image on the front of the paper is formed by the image forming units 8Y, 8M, 8C and 8K, and submitted to fixing processing by the fixing unit 9, it causes the paper to be shrunk by 0.2%.

In order to make a rate of inserting pixels to front-image data nearly equal to a rate of thinning pixels from back-image data, when representing the magnification of the front by (100+x) % and the magnification of the back by (100−x) %, the following equation is given for obtaining the rate x:

(100+x)×0.998=100−x

Since x is approximately 0.1, 100.1% for the magnification of the front and 99.9% for the back are stored in advance in the paper-kind vs. magnification table in the nonvolatile memory 64 corresponding to the paper with 0.2% heat-shrinkage percentage.

Since 7,016 pixels×0.1%≈7, 7 pixels may be preferably inserted into the front-image data, and 7 pixels thinned from the back-image data.

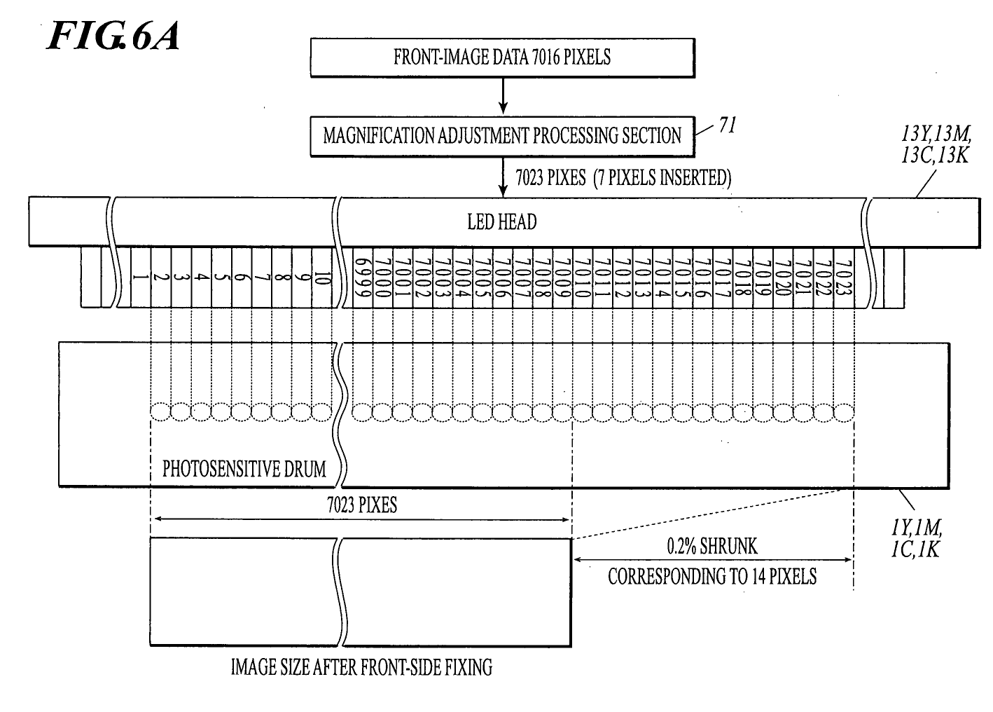

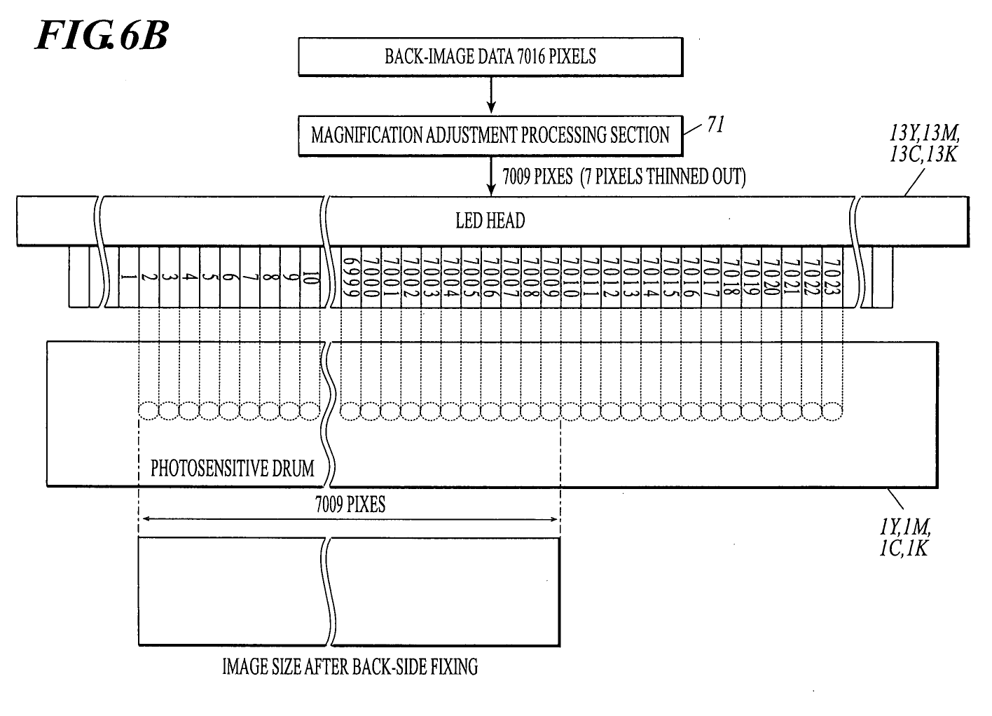

As shown in FIG. 6A, the magnification adjustment processing section 71 inserts 7 pixels into the front-image data 7,016 pixels, and the data of 7,023 pixels are sent to the LED heads 13Y, 13M, 13C and 13K. The paper P shrinks by 0.2% (corresponding to 14 pixels) by the fixing processing, therefore the image size after fixing the front corresponds to 7,009 pixels.

For the back-image, as shown in FIG. 6B, the magnification adjustment processing section 71 thins out 7 pixels, and the data of 7,009 pixels are sent to the LED heads 13Y, 13M, 13C and 13K. This makes the size of the front and back images nearly equal to each other.

When performing pixel inserting processing, pixels for one line may be divided by a constant interval, and a pixel may be inserted into a specific position within each divided interval. In this case, the position to be inserted may be changed in every line. Alternatively, pixels for one line may be divided by a constant interval, and a pixel may be randomly inserted within each divided interval. It is also possible to randomly insert pixels of the number of pixels to be inserted into one line of image data.

When performing pixel thinning processing, pixels for one line may be divided by a constant interval, and a pixel may be thinned out from a specific position within each divided interval. In this case, the position to be thinned may be changed in every line. Alternatively, pixels for one line may be divided by a constant interval, and a pixel may be randomly thinned out within each divided interval. It is also possible to randomly thin out pixels of the number of pixels to be thinned out from one line of image data.

Next, the operation of the color copier 100 will be explained.

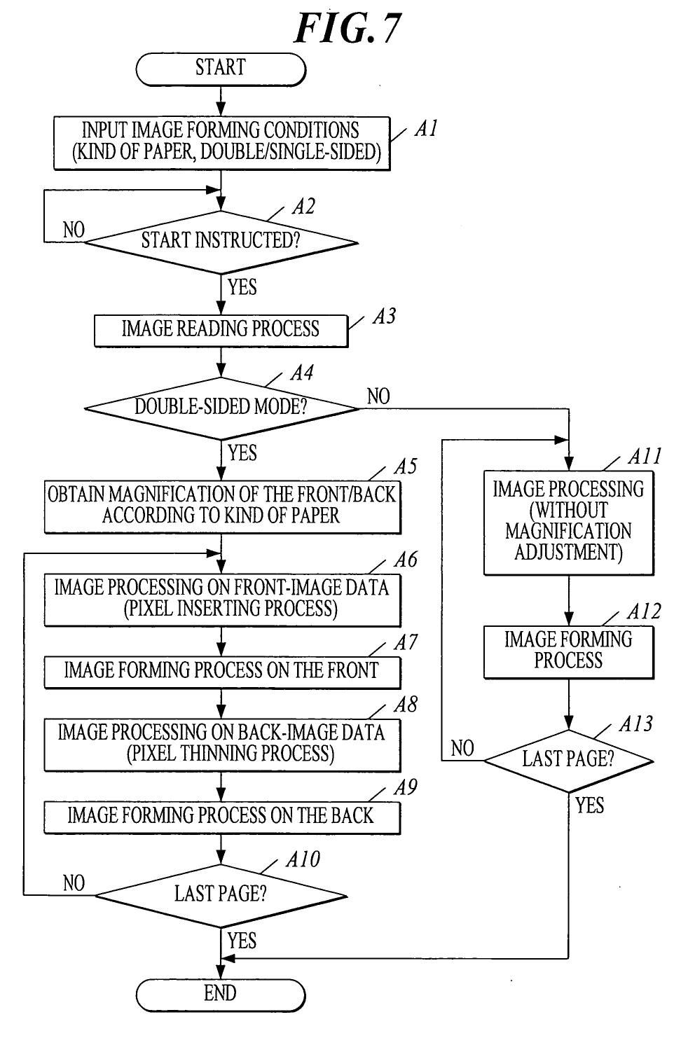

FIG. 7 is a flowchart showing an image forming processing executed by the color copier 100. This processing is implemented by the CPU 63 in cooperation with programs stored in the ROM 61.

First, a user operates the input setting section 51 of the operation panel 50 to input image forming conditions, such as the kind and size of the paper P, double/single sided mode, and the number of sheets to be copied (step A1).

Next, when the user instructs to start image formation from the input setting section 51 (YES at step A2), an image reading processing is performed by the image input section 30 according to the read control signal S1 (step A3). Read image data Din are stored into the image memory 67 according to the image memory control signal S2.

Next, it is determined whether a double-sided mode is set or a single-sided mode is set in inputting of image forming conditions at step A1 (step A4). When the double-sided mode is set (YES at step A4), the nonvolatile-memory control signal S6 is output to the nonvolatile memory 64, and magnifications of the front and the back corresponding to the kind of paper P are obtained based on the paper-kind vs. magnification table stored in the nonvolatile memory 64 (step A5).

Next, the image processing control signal S3 is output to the image processing section 70, and image processing is executed on the image data for the front by the image processing section 70 (step A6). The image data Dᵢₙ of RGB color system are first converted in color to image data Dy, Dm, Dc and Dk for YMCK colors, then the magnification adjustment processing section 71 executes the pixel inserting processing on the image data Dy, Dm, Dc and Dk to generate pixel-inserted image data Dy′, Dm′, Dc′ and Dk′.

Thereafter, the image forming section 10 performs the image forming processing onto the front of the paper P (step A7). At this time, the image data Dy′, Dm′, Dc′ and Dk′ corresponding to respective pixels are sent in every line to the LED writing units 3Y, 3M, 3C and 3K, respectively, and a color image is formed on the front of the paper P via the photosensitive drums 1Y, 1M, 1C and 1K and the intermediate transfer belt 5. For instance, image data Dy′ of Y color for every line and the image producing control signal S4 are input to the LED writing unit 3Y for Y color, and a Y-color toner image is formed on the photosensitive drum 1Y. After formation of a color image on the paper, the fixing unit 9 performs fixing processing.

Next, the image processing control signal S3 is output to the image processing section 70, and image processing is executed on the image data for the back by the image processing section 70 (step A8). The image data Dᵢₙ of RGB color system are first converted in color to image data Dy, Dm, Dc and Dk for YMCK colors, then the magnification adjustment processing section 71 executes the pixel thinning processing on the image data Dy, Dm, Dc and Dk to generate pixel-thinned image data Dy′, Dm′, Dc′ and Dk′.

Thereafter, the image forming section 10 performs the image forming processing onto the back of the paper P (step A9). At this time, the image data Dy′, Dm′, Dc′ and Dk′ corresponding to respective pixels are sent in every line to the LED writing units 3Y, 3M, 3C and 3K, respectively, and a color image is formed on the back of the paper P via the photosensitive drums 1Y, 1M, 1C and 1K and the intermediate transfer belt 5. Thereafter, the fixing unit 9 performs fixing processing.

Next, it is determined whether image formation of the last page has finished (step A10). When the image formation of the last page has not finished (NO at step A10), the processing returns to step A6, and processing from step A6 to step A10 is repeated. On the other hand, when the image formation of the last page has finished (YES at step A10), the image forming processing ends.

When the single-sided mode is set at step A4 (NO at step A4), the image processing control signal S3 is output to the image processing section 70, and image processing is executed on the image data by the image processing section 70 (step All). Here, the magnification adjustment processing is not performed in the magnification adjustment processing section 71.

Next, the image forming section 10 performs the image forming processing on the single-side surface of the paper P (step A12). At this time, the image data Dy, Dm, Dc and Dk corresponding to respective pixels are sent in every line to the LED writing units 3Y, 3M, 3C and 3K, respectively, and a color image is formed on the single-side surface of the paper P via the photosensitive drums 1Y, 1M, 1C and 1K and the intermediate transfer belt 5. Thereafter, the fixing unit 9 performs fixing processing.

Next, it is determined whether image formation of the last page has finished (step A13). When the image formation of the last page has not finished (NO at step A13), the processing returns to step A11, and processing from step A11 to step A13 is repeated. On the other hand, if the image formation of the last page has finished (YES at step A13), the image forming processing ends.

As described above, according to the color copier 100, the pixel inserting processing is executed for image data for the front of a sheet and the pixel thinning processing for the back. Accordingly, the difference in image quality between the front and the back of the sheet can be reduced, and the size of images on the front and the back can be equalized to each other.

Meanwhile, it is assumed for comparison that, when forming images of both sides of a paper sheet, the image size of the front and the back are equalized with magnification adjustment processing executed on image data for the back only. As in the embodiment described above, paper-shrinkage percentage of 0.2% and image data of 7,016 pixels are to be given.

Since 7,016 pixels×0.2%≈14, 14 pixels should be thinned out from the image data of the back.

On the contrary, in the embodiment described above, 7 pixels are inserted into the front-image data and 7 pixels are thinned out from the back-image data, so that the changing rates for the front-image data and the beck-image data are made substantially equal to each other relative to the original image data. Accordingly, the difference in image quality between the front and the back resulted from the magnification adjustment processing can be reduced.

The description of the above embodiment exemplifies the image forming apparatus according to the invention, however, is not limited to this embodiment. Appropriate changes may be made to detailed structure and operation of each component in the image forming apparatus without departing from the scope of the invention.

For instance, the writing head having aligned LED elements is described as an example in the above embodiment, however, the invention is also applicable to a PLZT (plomb lanthanum zirconate titanate) shutter array head, a liquid crystal head, an inkjet head or the like.

In case that writing elements can write with multi-level gradation, when a pixel inserting processing is executed, image data of pixels locating precedent and subsequent to a pixel to be inserted and/or image data of the pixel to be inserted may be corrected based on the image data of pixels locating precedent and subsequent to the pixel to be inserted. When a pixel thinning processing is executed, image data of pixels locating precedent and subsequent to a pixel to be thinned may be corrected based on the image data of pixels locating precedent and subsequent to the pixel to be thinned.

The paper-kind vs. magnification table is stored in the nonvolatile memory 64 in the above embodiment, however, kinds of paper may be correlated with the number of pixels to be inserted into the front image and the number of pixels to be thinned from the back image for each paper size, and stored in the memory.

In the above embodiment, the number of pixels to be inserted into the front-image data in the pixel inserting processing is equalized to the number of pixels to be thinned from the back-image data in the pixel thinning processing. Alternatively, with respect to the front-image data and the back-image data, a ratio to be changed from original data may be set arbitrarily.

The present U.S. patent application claims a priority under the Paris Convention of Japanese patent application No. 2006-61083 filed on Mar. 7, 2006, and shall be a basis of correction of an incorrect translation.

What is claimed is:

1. An image forming apparatus comprising:
an image forming section which has one or more writing head, each head having a plurality of writing elements arranged in a line, and forms images on both sides of a paper sheet; and
an image processing section which sends image data to each of the writing elements of the writing head,
wherein the image processing section executes a magnification adjustment processing on image data for the front surface and image data for the back surface in an arrangement direction of the writing elements according to a kind of the paper sheet.

2. The image forming apparatus of claim 1, wherein, when executing the magnification adjustment processing, the image processing section executes a pixel inserting processing on the image data for the front and executes a pixel thinning processing on the image data for the back.

3. The image forming apparatus of claim 2, wherein the number of pixels to be inserted into the image data for the front in the pixel inserting processing is substantially equal to the number of pixels to be thinned out from the image data for the back in the pixel thinning processing.

4. The image forming apparatus of claim 1, further comprising a storage section which stores a table correlating kinds of paper with a magnification for the front and a magnification for the back,
wherein the image processing section executes a magnification adjustment processing based on the magnification for the front and the magnification for the back, read from the storage section.

5. The image forming apparatus of claim 1, wherein the image forming section comprises a plurality of writing heads corresponding to respective color components of a color image and forms color images on both sides of the paper sheet.

6. The image forming apparatus of claim 1, wherein the kind of the paper is a kind based on a thickness of the paper.

7. The image forming apparatus of claim 1, wherein the writing head is an LED writing head.

8. A double-sided image forming method for forming images on a first surface and a second surface of a paper sheet with use of a writing head having a plurality of writing elements arranged in a line, the method comprising the steps of:
obtaining a magnification for the first surface and a magnification for the second surface corresponding to a kind of the paper;
executing a magnification adjustment processing on image data for the first surface in an arrangement direction of the writing elements based on the magnification for the first surface and sending the magnification-adjusted image data to each of the writing elements of the writing head to form an image of the first surface; and
executing a magnification adjustment processing on image data for the second surface in the arrangement direction of the writing elements based on the magnification for the second surface and sending the magnification-adjusted image data to each of the writing element of the writing head to form an image of the second surface.

9. The double-sided image forming method of claim 8, wherein a pixel inserting processing is executed on the image data for the first surface when the magnification adjustment processing is executed on the image data for the first surface, and a pixel thinning processing is executed on the image data for the second surface when the magnification adjustment processing is executed on the image data for the second surface.

10. The double-sided image forming method of claim 9, wherein the number of pixels to be inserted into the image data for the first surface in the pixel inserting processing is substantially equal to the number of pixels to be thinned out from the image data for the second surface in the pixel thinning processing.

11. The double-sided image forming method of claim 8, wherein, in the step of obtaining the magnification for the first surface and the magnification for the second surface, a table which is stored in advance and correlates kinds of paper sheets with the magnification for the first surface and the magnification for the second surface, is referred for obtaining the magnification for the first surface and the magnification for the second surface corresponding to a kind of paper.

12. The double-sided image forming method of claim 8, wherein the kind of paper is a kind based on thickness of the paper.

13. The double-sided image forming method of claim 8, wherein the writing head is an LED writing head.

14. An image forming apparatus comprising:
an image forming section which has a writing head having a plurality of writing elements arranged in a line and forms images on both sides of a paper sheet;
an image processing section which sends image data to each of the writing elements of the writing head; and
a storage section which stores in advance magnifications for the front surface and for the back surface in pairs,
wherein the image processing section executes a magnification adjustment processing in an arrangement direction of the writing elements with the magnification for the front surface applied to image data for the front and the magnification for the back surface applied to image data for the back.

15. The image forming apparatus of claim 14, wherein, when executing the magnification adjustment processing, the image processing section executes a pixel inserting processing on the image data for the front, and a pixel thinning processing on the image data for the back.

16. The image forming apparatus of claim 15, wherein the number of pixels to be inserted into the image data for the front in the pixel inserting processing is substantially equal to the number of pixels to be thinned out from the image data for the back in the pixel thinning processing.

17. The image forming apparatus of claim 14, wherein the kind of paper is a kind based on thickness of the paper.

18. The image forming apparatus of claim 14, wherein the writing head is an LED writing head.
